(19) United States
(12) Patent Application Publication
(10) Pub. No.: US 2010/0016028 A1
(43) Pub. Date: Jan. 21, 2010

(54) ELECTRONIC DEVICE AND MOBILE COMMUNICATION TERMINAL

(75) Inventors: Akihiro TAKENAKA, Tokyo (JP); Masaaki ARAI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/489,815

(22) Filed: Jun. 23, 2009

(30) Foreign Application Priority Data
Jul. 18, 2008 (JP) 2008-187749

(51) Int. Cl. H04M 1/00; H04B 1/38

(52) U.S. Cl. 455/566; 455/574

(57) ABSTRACT

An electronic device such as a cellular phone is described in which a storage device stores a table including a plurality of pairs of a luminance level and settable lighting time period for a display unit. The electronic device checks whether a lighting time of the display unit set by a user satisfies a predetermined settable lighting time period, and corrects the lighting time so as to satisfy the predetermined settable lighting time period when detecting the deviation.

### CROSS-REFERENCE TO RELATED APPLICATIONS

This application is based upon and claims the benefit of priority from prior Japanese Patent Application No. 2008-187749, filed Jul. 18, 2008, the entire contents of which are incorporated herein by reference.

### BACKGROUND OF THE INVENTION

1. Field of the Invention

Exemplary embodiments of the present invention relate to an electronic device which controls lighting duration of a display unit if no input is received after the display unit is turned on or a backlight of the display unit is turned on.

2. Description of the Related Art

Recently, performance of a display unit of an electronic device such as a cellular phone has improved and a large amount of information can be displayed on the display unit at the same time. Also, the quality of the display unit has been enhanced. However, power consumption of the display unit has increased along with the enhancement of the quality of the display, and there arises a problem that users need to recharge a battery of the cellular phone more frequently.

To achieve power saving, the electronic device, such as the cellular phone, turns off the display unit temporarily in a case that no manipulation is input for a predetermined time period. However, a fixed time period is set as the predetermined time period even though electric power consumption varies according to executed functions in the cellular phone. Therefore, a user cannot set a suitable time period to the cellular phone in view of the electric power consumption.

To solve the problem above, Jpn. Pat. Appln. KOKAI Publication No. 2004-23496 (Furuhata) discloses a mobile terminal such as a cellular phone with a backlight under a display unit, and has a function for turning the backlight on and off. A lighting time period of the backlight can be varied in accordance with an operation mode to reduce the electric power consumption. A user sets the lighting time period for each operation mode into the cellular phone, and the cellular phone reads out the lighting time period according to an activated operation mode and continues to have the backlight on until a no key input period reaches the lighting time period.

The method disclosed in Furuhata flexibly controls the lighting time period according to the activated operation mode. For example, in such a mode that the cellular phone does not use the display unit frequently, the electric power consumption by lighting the display unit can be cut by setting a shorter lighting time period.

### BRIEF SUMMARY OF THE INVENTION

Exemplary embodiments of the present invention provide an electronic device which reduces power consumption by controlling a lighting time of a display unit according to luminance set for the display unit.

An electronic device includes: a display control unit configured to control a display unit; a storage device configured to store a luminance and a lighting time for the display unit, and a table including a plurality of pairs of a luminance level and a settable lighting time period; a judging unit configured to obtain the settable lighting time period corresponding to the luminance stored in the storage device, and to judge whether the lighting time stored in the storage device satisfies the settable lighting time period corresponding to the luminance stored in the storage device; a setting unit configured to correct the lighting time stored in the storage device if the judging unit detects that the lighting time does not satisfy the settable lighting time period corresponding to the luminance stored in the storage device; and a control unit configured to instruct the display control unit to turn off the display unit if no operation is detected within the lighting time stored in the storage device.

### BRIEF DESCRIPTION OF THE SEVERAL VIEWS OF THE DRAWING

The accompanying drawings, which are incorporated in and constitute a part of the specification, illustrate exemplary embodiments of the invention, and together with the general description given above and the detailed description of the exemplary embodiments given below, serve to explain the exemplary embodiments of the invention.

FIG. 1 shows an exemplary appearance of a cellular phone;

FIG. 2 is a block diagram of the cellular phone;

FIG. 3 shows a data structure of restriction information;

FIG. 4 is a flowchart for explaining a procedure of setting process regarding the cellular phone;

FIGS. 5A-5D show a screen transition when setting control period regarding a display unit of the cellular phone;

FIG. 6 is a flowchart showing a procedure to control the display unit by the cellular phone; and

FIG. 7 is a table showing a relationship between electric power consumption and luminance.

### DETAILED DESCRIPTION OF THE INVENTION

Exemplary embodiments of the present invention will be described hereinafter with reference to the accompanying drawings.

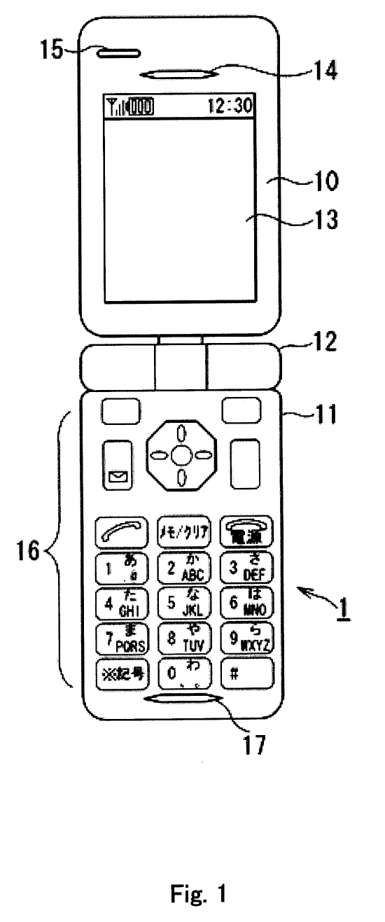

FIG. 1 shows an exemplary arrangement of a cellular phone 1 as an example of an electronic device. As shown in FIG. 1, the cellular phone 1 is composed of a first housing 10 and a second housing 11 similar to the first housing in size, and both housings are rotatably connected via a hinge unit 12.

A front surface of the first housing 10, which faces a front surface of the second housing 11 when the cellular phone 1 is in a closed state, is equipped with a display unit 13 for displaying letters and pictures and so on. The display unit 13 can be a liquid crystal display (LCD) or an organic light emitting display (OLED). The LCD displays data by using the shutter effect on a backlight which occurs by applying a voltage to liquid crystal molecules, and the OLED displays data by using the luminance phenomenon of excitons which is generated as a result of combining electrons and electron holes in organic compounds.

Also, the first housing 10 is equipped with a speaker 14 for outputting a voice and an illuminance sensor 15 for detecting surrounding illuminance. The display unit 13, the speaker 14, and illuminance sensor 15 are covered by the second housing 11 when the cellular phone 1 is in the closed state.

On the other hand, the front surface of the second hosing 11, for example, is equipped with operation keys 16, such as a power key for turning on and off the cellular phone 1, a call key for making an outgoing call, a numeric keypad for inputting numbers and characters, and short-cut keys for activating a mail function and web browsing function. This listing of keys is exemplary, and people skilled in the art know that additional keys may be present. Also, a microphone 17 that captures a voice is located inside of the second housing 11. The operation keys 16 and the microphone 17 are covered by the first housing 10 when the cellular phone 1 is in the closed state.

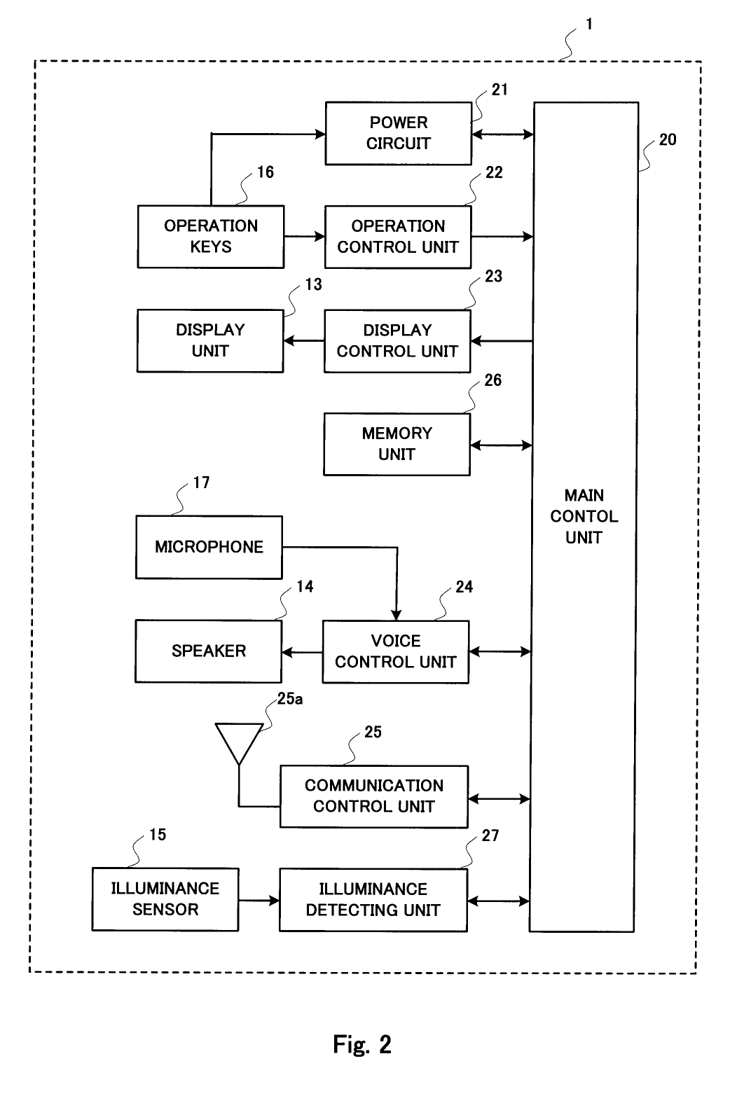

Next, the functions regarding the cellular phone 1 will be explained with reference to FIG. 2. As shown in FIG. 2, the cellular phone 1 is composed of a main control unit 20, power circuit 21, a key operation control unit 22, a display control unit 23, a voice control unit 24, a communication control unit 25, memory unit 26, and illuminance detecting unit 27. These units and circuit from 20 through 27 are connected with a bus and communicate each other via the bus.

The cellular phone 1 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The main control unit 20 is equipped with a CPU (Central Processing Unit), and entirely controls the cellular phone 1. For example, the main control unit 20 controls display control processing which will be described in detail later, arithmetic processing, and control processing.

The power circuit 21 is connectable to a rechargeable battery, turns on and off the cellular phone 1 by responding to an input via the power key of the operation keys 16, and switches the cellular phone 1 into an operable state by supplying electric power to each unit and circuit from the rechargeable battery.

The key operation control unit 22 is equipped with an interface with the operation keys 16 and transmits a key input signal to the main control unit 20 corresponding to a depressed key of the operation keys 16 when detecting the key depression.

The display control unit 23 is equipped with an interface with the display unit 13 and, under the control of the main control unit 20, turns on and off the display unit 13. The display control unit 23 may display text data and picture data stored in the memory unit 26, and text data and picture data received via the communication control unit 25. Furthermore, the display control unit 23 can display a broadcasted TV program on the display unit 13. If the display 13 is the OELD, the display control unit 23 controls luminance of the display unit 13, and if the display 13 is the LCD, the display control unit 23 controls the backlight located under the display unit 13.

The voice control unit 24 converts analog voice signals inputted via the microphone 17 into digital voice signals, and also, converts digital signals into analog voice signals to be outputted from the speaker 14, under the control of the main processing unit 20.

The communication control unit 25, under the control of the main control unit 20, obtains data including digital voice signals, coded picture data, and control data by despreading radio signals with a spreading code and demodulating the despread radio signals received via an antenna 25a from a base station. The digital voice signals are outputted to the voice control unit 24, the coded picture data is outputted to the display control unit 23, via a picture decoder, so as to display the picture data on the display unit 13, or the coded picture data is outputted to the memory unit 26. On the other hand, the communication control unit 25, under the control of the main control unit 20, modulates digital voice signals from the voice control unit 24, control data, and alphanumeric data inputted via the operation keys 16, spreads the modulated digital voice signals, control data, and alphanumeric data, and obtains radio signals to be transmitted to the base station via the antenna 25a.

The memory unit 26 may be a ROM (Read Only Memory), a hard disk, or a nonvolatile memory, and stores programs to be executed by the main control unit 20. A person of ordinary skill in the art will recognize that other memory device may be used. Also, the memory unit 26 includes a RAM (Random Access Memory) which temporarily stores operation data used by the main processing unit 20 while executing the program. For example, a program to be used for controlling display processing is stored in the ROM.

The illuminance detecting unit 27, under the control of the main control unit 20, receives the surrounding illuminance from the illuminance sensor 15 and generates an illuminance level signal to be transmitted to the main control unit 20.

The cellular phone 1 turns off the display unit 13 when the display unit 13 is turned on and no manipulation is detected for a predetermined time period so as to reduce the electric power consumption at the display unit 13. Generally, as for the OELD, the luminance can be adjusted by increasing or decreasing the electrical current to be supplied to the display unit 13. Also, as for the LCD such as a transmittal liquid crystal display or a semi-transmittal LCD, the luminance can be adjusted by increasing or decreasing the electric current to be supplied to the backlight, such as a white LED. Consequently, the electric current varies according to the change in the luminance of the display unit 13. Namely, the electric power consumption increases as the luminance increases, and the high luminance results in frequent battery exhaustion.

So, the cellular phone 1 sets the maximum lighting time period according to the luminance setting for the OELD and the luminance setting for the backlight of the LCD so as to reduce the electric power consumption caused by turning on the display unit 13.

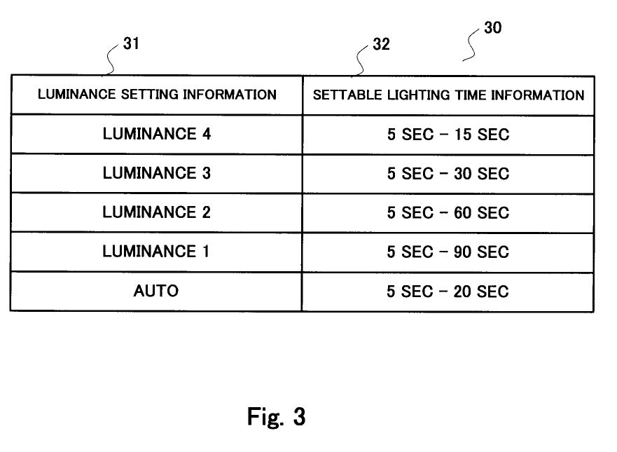

The memory unit 26 of the cellular phone 1 stores restriction information 30 (FIG. 3). The restriction information 30 is information consisting of a plurality of pairs of luminance setting information 31 identifying a luminance level and settable lighting time information 32 which is defined by the minimum lighting time and maximum lighting time. The cellular phone 1 controls the lighting time of the display unit 13 based on the restriction information 30.

For example, as shown in FIG. 3, the highest luminance level, luminance 4, of the luminance setting information 31 corresponds to the settable time of between 5 seconds (minimum lighting time) and 15 seconds (maximum lighting time). This information shows that the lighting time can be selected between 5 seconds and 15 seconds if luminance 4 is set. Also, the second highest luminance level, luminance 3, corresponds to the settable time of between 5 seconds (minimum lighting time) and 30 seconds (maximum lighting time), the third highest luminance level, luminance 2, corresponds to the settable time of between 5 seconds (minimum lighting time) and 60 seconds (maximum lighting time), and the lowest luminance level, luminance 1, corresponds to the settable time of between 5 seconds (minimum lighting time) and 90 seconds (maximum lighting time) respectively. Furthermore, an automatic mode, which corresponds to the settable time of between 5 seconds (minimum lighting time) and 20 seconds (maximum lighting time), can be selected for the luminance setting information 31 as shown in FIG. 3. In the automatic mode, luminance is set according to the surrounding illuminance level.

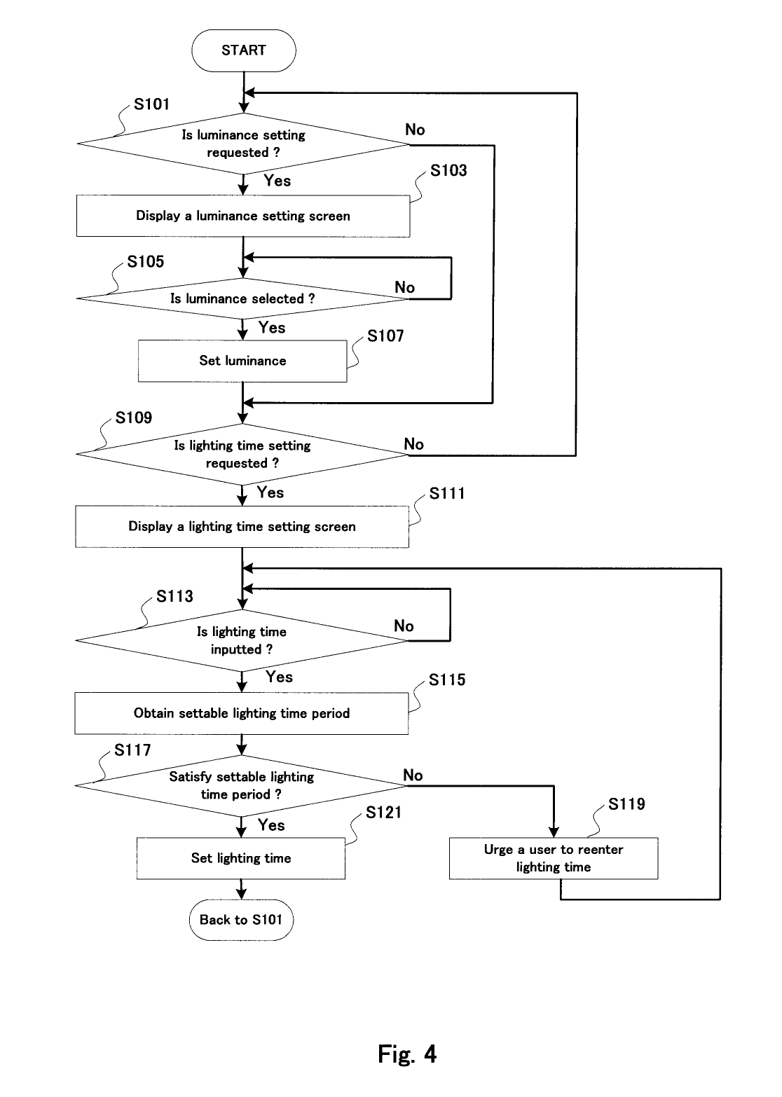

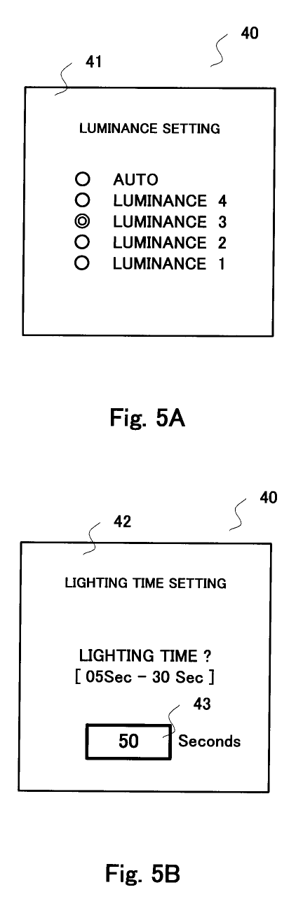

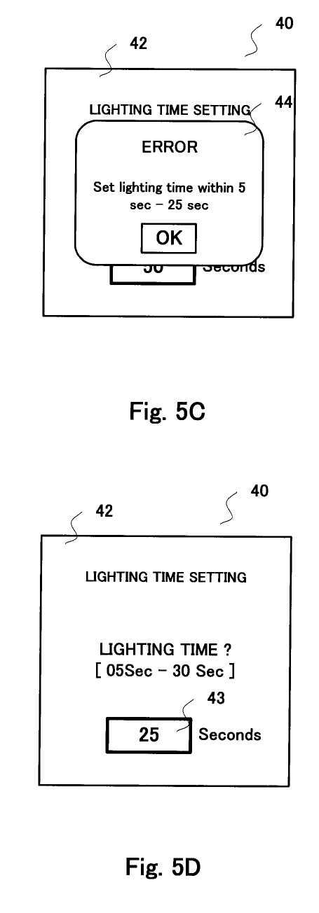

Hereinafter, the procedure on how the main control unit 20 of the cellular phone 1 sets the luminance and the lighting time of the display unit 13 will be explained with reference to FIGS. 4 and 5.

First, the main control unit 20 checks whether an instruction to set the luminance for the display unit 13 is requested (step S101), and the main control unit 20 determines the luminance setting is requested when a given key of the operation keys 16 is depressed by the user.

If the luminance setting is requested (Yes at step S101), the main control unit 20 displays a luminance setting screen 41 on a display screen 40 of the display unit 13 (step S103). As shown in FIG. 5A, the luminance setting screen provides the user with options such as the ‘automatic’, ‘luminance 4’, and ‘luminance 3’, and so on. Then, the user can select one of the options by manipulating the operation keys 16.

The main control unit 20 checks whether the luminance for the display unit 13 is selected from the options by manipulating the operation keys 16 (step S105). If no selection is done by the user (No at step S105), then the main control unit 20 stands by until the selection of the luminance is done. On the other hand, if the selection of the luminance is done by the user (Yes at step S105), the main control unit 20 sets the selected luminance for the display unit 13 (step S107). In this case, the ‘luminance 3’ is selected in step S105 as shown in FIG. 5A, and the ‘luminance 3’ is set as the luminance of the display unit 13.

In step S107, after the ‘luminance 3’ is set as the luminance of the display unit 13, or while no selection from the options regarding luminance is received (No at step S101), the main control unit 20 checks whether an instruction to set the lighting time of the display unit 13 is requested by manipulating the operation keys 16 (step S109).

If the setting of lighting time is instructed (Yes at step S109), the main control unit 20 displays a lighting time setting screen 42 on the display screen 40 of the display unit 13 (step S111). As shown in FIG. 5B, the lighting time setting screen 42 includes a blank 43 so that the user inputs the lighting time into the cellular phone 1. The user inputs in intended lighting time in the blank 43 by manipulating the operation keys 16.

The main control unit 20 checks whether the lighting time is inputted (step S113). If the lighting time is not inputted (No at step S113), the main control unit 20 stands by until the lighting time is inputted. On the other hand, if the lighting time is inputted into the blank 43 (Yes at step S113), the main control unit 20 reads out the settable lighting time information 32 from the memory unit 26 (step S115). In this case, the main control unit 20 obtains the luminance set for the display unit 13 if the luminance is inputted in step S115, or the previous luminance set for the display unit 13 if the luminance is not inputted in step S107, and subsequently, the main control unit 20 obtains the settable lighting time information 32 corresponding to the obtained luminance set for the display unit 13.

For example, in the case that ‘luminance 3’ is set in step S107, the main control unit 20 obtains the settable time of between 5 seconds and 30 seconds as the settable lighting time information 32 corresponding to the ‘luminance 3’ of the luminance setting information 31 in the restriction information 30.

The main control unit 20 checks whether the lighting time inputted in step S113 satisfies the settable lighting time information 32 (step S117). In this case, the main control unit 20 determines that the lighting time is valid if the lighting time inputted in step s113 is within the settable lighting time information 32.

If the inputted lighting time does not satisfy the settable lighting time information 32 (No at step S117), the main control unit 20 urges the user to reenter the lighting time (step S119). For example, as shown in FIG. 5B, in a case that 50 seconds is inputted, since this time does not satisfy the settable time of between 5 seconds and 30 seconds in the settable lighting time information 32, the main control unit 20 urges the user to reenter the lighting time. When urging, the main control unit 20 displays an error message screen 44 as shown in FIG. 5C on the display screen 40 of the display unit 13. In the error message screen 44, a message like ‘Please enter the lighting time between 5 seconds and 30 seconds.’ is displayed. As shown in FIG. 4, the flowchart may return to step S113, and the main control unit 20 again checks whether a new lighting time is inputted.

If the inputted lighting time satisfies the settable lighting time information 32 (Yes at step S117), the main control unit 20 determines the inputted lighting time as the lighting time of the display unit 13. For example, 25 seconds is inputted as the lighting time as shown in FIG. 5D. Since this time satisfies the settable lighting time information 32 of between 5 seconds and 30 seconds, the main control unit 20 sets the time, 25 seconds, as the lighting time of the display unit 13.

After setting the lighting time for the display unit 13 in step S121 or in the case that no instruction is inputted (No at step S109), the flowchart may return to step S101, and the main control unit 20 again checks whether the luminance setting is instructed. In this case, a stand-by screen or a wall-paper screen is displayed on the display unit 13. As described above, the main control unit 20 repeats the processes over steps S101 through S121, and the lighting time and the luminance for the display unit 13 can be set.

Thus, since the lighting time is restricted according to the luminance of the display unit 13, the user sets the lighting time within the restriction based on the luminance of the display unit 13.

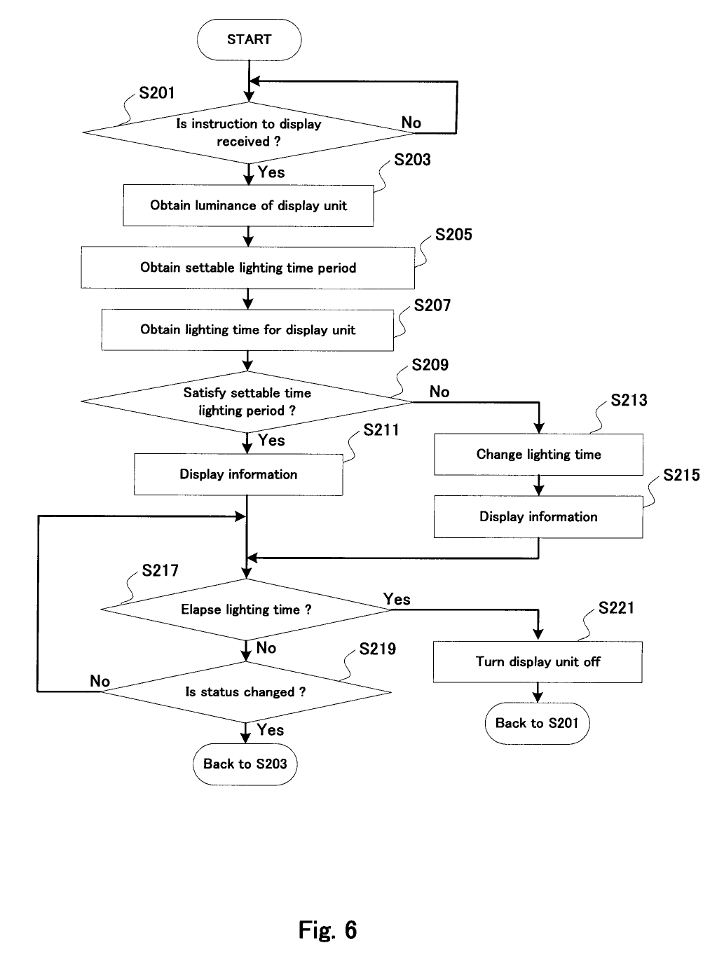

Next, it is described that the main control unit 20 of the cellular phone 1 controls the display unit 13 based on the luminance and the lighting time set by the user with reference to FIG. 6. In this case, it is assumed that ‘luminance 3’ and 25 seconds are set as the luminance and the lighting time for the display unit 13, respectively.

The main control unit 20 checks whether an instruction instructing to display information on the display unit 13 is received (step S201). For example, according to a depression of the operation keys 16 by the user or a completion of some processing, such as ready for preparing displayed data, the main control unit 20 detects the instruction to display the information on the display unit 13. If no instruction instructing to display the information on the display unit 13 is received (No at step S201), the main control unit 20 remains in a stand-by state.

If the instruction instructing to display the information on the display unit 13 is received (Yes at step S201), the main control unit 20 obtains, from restriction information 30 in the memory unit 26, the luminance for the display unit 13 set in step S107 (step S203). Subsequently, the main control unit 20 obtains the settable lighting time information 32 from the restriction information 30 corresponding to the obtained luminance in step S203 (step S205). For example, the ‘luminance 3’ is obtained in step S203, the ‘settable time of between 5 seconds and 30 seconds’ as the settable lighting time information 32, which corresponds the ‘luminance 3’ of the luminance setting information 31, is obtained.

The main control unit 20 obtains the lighting time for the display unit 13 set in step S121 (step S207), and checks whether the obtained lighting time satisfies the obtained settable lighting time (step S209).

If the lighting time satisfies the obtained settable lighting time (Yes at step S209), the main control unit 20 starts displaying information on the display unit 13 as instructed in step S101 (step S211). As described above, the lighting time, 25 seconds, satisfies the obtained settable lighting time information of between 5 seconds and 30 seconds.

If not (No at step S209), the main control unit 20 corrects the lighting time of the display unit 13 (step S213). For example, if the user changes the luminance from the ‘luminance 3’ to the ‘luminance 4’, the lighting time, 25 seconds, falls outside the allowable range for the settable lighting time information 32 corresponding to the ‘luminance 4’. In this case, it is preferable that the main control unit 20 updates the lighting time to 15 seconds which is the maximum lighting time for the ‘luminance 4’. Then, the main control unit 20 displays the information on the display unit 13 as instructed in step S101 (S215).

After the information is displayed on the display unit 13 according to the processes described in steps S211 or S215, the main control unit 20 checks whether the lighting time, which corresponds to the obtained lighting time in step S207 or corrected lighting time in step S213, has elapsed (step S217). If the lighting time has not elapsed (No at step S217), the main control unit 20 checks whether the status of the cellular phone 1 is changed (step S219). For example, the main control unit 20 determines that the status of the cellular phone 1 is changed when the user manipulates the operation keys 16 and a running operation is finished.

If the status of the cellular phone 1 is not changed (No at step S219), the flowchart may turn to step S203, and the main control unit 20 again executes the processes according to steps S203 through S221.

Thus, after starting to display the information on the display unit 13, the main control unit 20 of the cellular phone 1 turns off based on the lapse of time if the lighting time is within the settable lighting time information. On the other hand, the main control unit 20 corrects the lighting time if the lighting time deviates the settable lighting time information, and the main control unit 20 turns off the display unit 13 based on the corrected lighting time.

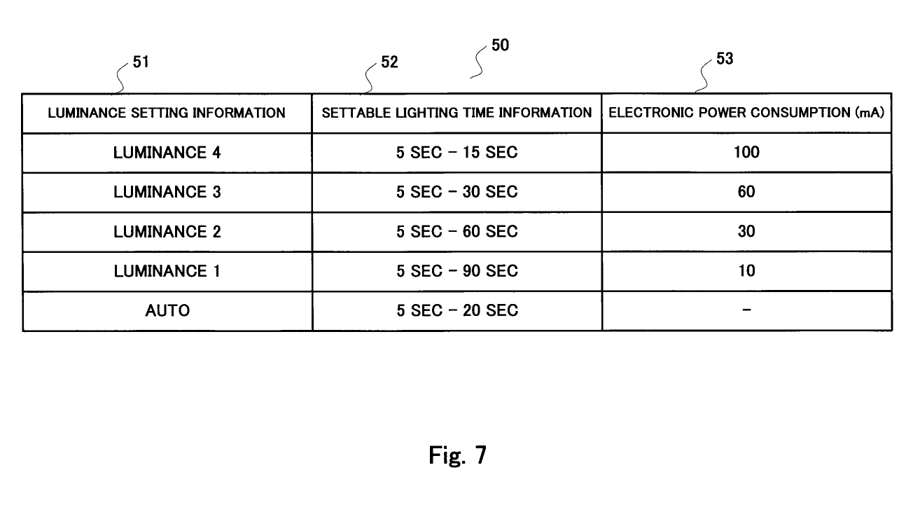

FIG. 7 shows an example of relationship between the luminance and the electric power consumption. According to FIG. 7, the ‘luminance 4’, the ‘luminance 3’, the ‘luminance 2’ and the ‘luminance 1’ in the luminance setting information 51 correspond to ‘100 mA’, ‘60 mA’, ‘30 mA’, and ‘10 mA’ in electric power consumption information 53, respectively.

For example, if the ‘luminance 4’ is set for the display unit 13, and 60 seconds as the lighting time is set according to the prior art, the amount of consumption current is as follows:

Lighting time period*consumption current=60 seconds*100 mA=6,000 mA·second

However, in this embodiment, the lighting time is limited within 15 seconds for the ‘luminance 4’; therefore, the amount of consumption is as follows:

Lighting time period * consumption current=15 seconds*100 mA=1,500 mA·second

Consequently, in this embodiment, the electric power consumption can be reduced to one-fourth during no operation.

In the case that the luminance of the display unit 13 is changed according to the surrounding illuminance detected by the illuminance sensor 15, the electric power saving can be realized by changing the lighting time according to the consumption current as described in steps S201 through S221.

According to the cellular phone 1 described in this embodiment, the lighting time of the display unit 13 during no operation is restricted according to the consumption current caused at the display unit 13. Therefore, the electric power saving can be realized by reducing the electric power consumption without degrading the display quality of the display unit 13.

In the above description, the cellular phone 1 is used to explain the embodiment. However, this invention can be applied to a PHS (Personal Handyphone system), a PDA (personal Digital Assistance), a small TV device, a digital camera, a video camera, a portable audio device, a portable video camera, and other devices having a display unit.

The cellular phone 1, or any of the other devices referred to supra, performs a portion or all of the processing steps of the above-noted embodiments in response to the main control unit 20 (and its CPU and associated control units) executing one or more sequences of one or more instructions contained in a memory, such as the memory unit 26. Such instructions may be read into the memory unit 26 from another computer readable medium, such as a hard disk or a removable media drive. One or more processors in a multi-processing arrangement may also be employed to execute the sequences of instructions contained in the memory unit 26. In alternative embodiments, hard-wired circuitry may be used in place of or in combination with software instructions. Thus, embodiments are not limited to any specific combination of hardware circuitry and software.

As stated above, the cellular phone 1 includes at least one computer readable medium or memory for holding instructions programmed according to the teachings of the above-noted embodiments and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

What is claimed is:

1. An electronic device comprising:
a display control unit configured to control a display unit;
a storage device configured to store a luminance and a lighting time for the display unit, and a table including a plurality of pairs of a luminance level and a settable lighting time period;
a judging unit configured to obtain the settable lighting time period corresponding to the luminance stored in the storage device, and to judge whether the lighting time stored in the storage device satisfies the settable lighting time period corresponding to the luminance stored in the storage device;
a setting unit configured to correct the lighting time stored in the storage device if the judging unit detects that the lighting time does not satisfy the settable lighting time period corresponding to the luminance stored in the storage device; and
a control unit configured to instruct the display control unit to turn off the display unit if no operation is detected within the lighting time stored in the storage device.

2. The electronic device according to claim 1, further comprising:
a key input unit, which includes a plurality of keys, configured to input the lighting time and the luminance to be stored in the storage device;
wherein, the judging unit is configured to judge, when the lighting time is inputted via the key input unit, whether the inputted lighting time satisfies the settable lighting time period corresponding to the luminance stored in the storage device.

3. The electronic device according to claim 1, wherein the setting unit is configured to correct the lighting time stored in the storage device by updating the lighting time in the storage device to a maximum lighting time of the settable lighting time period corresponding to the luminance stored in the storage device.

4. The electronic device according to claim 1, wherein in the table, a maximum lighting time of the settable lighting time period decreases as the luminance level increases.

5. The electronic device according to claim 4, wherein the judging unit is configured to obtain, when the luminance stored in the storage device is changed via the key input unit, other settable lighting time period corresponding to the changed luminance from the storage device and to check whether the lighting time stored in the storage satisfies the other settable lighting time period, and the setting unit is configured to correct the lighting time in the storage device by updating the lighting time in the storage device to a maximum lighting time of the other settable lighting time period.

6. A mobile communication terminal comprising:
an interface configured to communicate with a base station;
a display control unit configured to control a display unit;
a storage device configured to store a luminance and a lighting time for the display unit, and a table including a plurality of pairs of a luminance level and settable lighting time period;
a judging unit configured to obtain the settable lighting time period corresponding to the luminance stored in the storage device, and to judge whether the lighting time stored in the storage device satisfies the settable lighting time period corresponding to the luminance stored in the storage device;
a setting unit configured to correct the lighting time stored in the storage device if the judging unit detects that the lighting time does not satisfy the settable lighting time period corresponding to the luminance stored in the storage device; and
a control unit configured to instruct the display control unit to turn off the display unit if no operation is detected within the lighting time stored in the storage device.

7. The mobile communication terminal according to claim 6, further comprising:
a key input unit, which includes a plurality of keys, configured to input the lighting time and the luminance to be stored in the storage device;
wherein, the judging unit is configured to judge, when the lighting time is inputted via the key input unit, whether the inputted lighting time satisfies the settable lighting time period corresponding to the luminance stored in the storage device.

8. The mobile communication terminal according to claim 6, wherein the setting unit is configured to correct the lighting time stored in the storage device by updating the lighting time in the storage device to a maximum lighting time of the settable lighting time period corresponding to the luminance stored in the storage device.

9. The mobile communication terminal according to claim 6, wherein in the table, a maximum lighting time of the settable lighting time information decreases as the luminance level increases.

10. The mobile communication terminal according to claim 9, wherein the judging unit is configured to obtain, when the luminance stored in the storage device is changed via the key input unit, other settable lighting time period corresponding to the changed luminance from the storage device and to check whether the lighting time stored in the storage device satisfies the other settable lighting time period, and the setting unit is configured to correct the lighting time in the storage device by updating the lighting time in the storage device to a maximum lighting time of the other settable lighting time period.

11. An electronic device comprising:
means for controlling a display unit;
means for storing a luminance and a lighting time for the display unit, and a table including a plurality of pairs of a luminance level and a settable lighting time period;
means for obtaining the settable lighting time period corresponding to the luminance stored in the storage device;
means for judging whether the lighting time stored in the means for storing satisfies the settable lighting time period corresponding to the luminance stored in the means for storing; and
means for correcting the lighting time stored in the means for storing if the means for judging detects that the lighting time does not satisfy the settable lighting time period corresponding to the luminance stored in the storage device, wherein
the means for controlling turns off the display unit if no operation is detected within the lighting time stored in the storage device.
